(19) United States
(12) Patent Application Publication
(10) Pub. No.: US 2010/0149576 A1
(43) Pub. Date: Jun. 17, 2010

(54) IMAGE FORMING APPARATUS

(75) Inventor: Kazushige MORIHARA, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/638,189

(22) Filed: Dec. 15, 2009

Related U.S. Application Data
(60) Provisional application No. 61/138,093, filed on Dec. 16, 2008.

(51) Int. Cl. G06F 3/12

(52) U.S. Cl. 358/1.13; 358/1.15

(57) ABSTRACT

The present invention provides a technique that can prevent an increase in power consumption due to intermittent execution of print jobs with low execution priorities and contribute to a reduction in CO₂ emission. The technique is to discriminate content of a received print job, cause a storage medium to temporarily store, in a predetermined storage area, a print job discriminated as having first content with a low execution priority and cause an image forming apparatus to execute, together with the print job having the first content stored in the predetermined storage area, a print job discriminated by the job discriminating unit as having second content that should be more preferentially executed than the first content.

### CROSS-REFERENCE TO RELATED APPLICATION

This application is based upon and claims the benefit of priority from: U.S. provisional application 61/138,093, filed on Dec. 16, 2008, the entire contents of each of which is incorporated herein by reference.

### TECHNICAL FIELD

The present invention relates to a technique that contributes to a reduction in power consumption in an image forming apparatus.

### BACKGROUND

In the past, there is known an image forming apparatus configured to execute various kinds of image processing on the basis of commands transmitted through a network.

The image forming apparatus in the past returns from a “sleep mode”, which is a stopped state in which the image forming apparatus does not perform print operation, and starts the print operation upon receiving a print job from an external communication terminal such as a PC (Personal Computer) through the network. The image forming apparatus is controlled to shift to the sleep mode again after finishing the print operation.

However, when the image forming apparatus intermittently receives print jobs (many times in every fixed time) from the external communication apparatus, the image forming apparatus repeats operation for shifting to the sleep mode and operation for returning from the sleep mode many times in such a manner as (1) shift to the sleep mode, (2) reception of a print job, (3) return from the sleep mode, (4) execution of printing, (5) shift to the sleep mode after the elapse of the fixed time, (6) receive a print job, (7) return from the sleep mode, (8) execute printing, and (9) shift to sleep mode after the elapse of the fixed time.

In particular, when the image forming apparatus returns from the sleep mode to an operation state in which printing is possible, the temperature of a fixing device provided in the image forming apparatus needs to be raised to predetermined temperature. This causes a substantial increase in CO₂ emission.

### SUMMARY

This specification relates to an image forming apparatus including: a job receiving unit configured to receive a print job; a job discriminating unit configured to discriminate content of the print job received by the job receiving unit; and a job managing unit configured to cause a storage medium to temporarily store, in a predetermined storage area, a print job discriminated by the job discriminating unit as having first content with a low execution priority and cause the image forming apparatus to execute, together with the print job having the first content stored in the predetermined storage area, a print job discriminated by the job discriminating unit as having second content that should be more preferentially executed than the first content.

This specification also relates to an image forming apparatus including: a job receiving unit configured to receive a print job; a job discriminating unit configured to discriminate content of the print job received by the job receiving unit; and a job managing unit configured to cause a storage medium to temporarily store, in a predetermined storage area, a print job discriminated by the job discriminating unit as having first content with a low execution priority and cause, when a sum of predetermined parameters concerning all print jobs stored in the predetermined storage area exceeds a predetermined value, the image forming apparatus to execute all the print jobs stored in the predetermined storage area.

This specification also relates to an image forming apparatus including: a job receiving unit configured to receive a print job; a job storing unit configured to cause a storage medium to store the print job received by the job receiving unit in a predetermined storage area; a job discriminating unit configured to discriminate content of the print job stored in the predetermined storage area by the job storing unit; and a job managing unit configured to cause, when a print job discriminated by the job discriminating unit as having second content that should be more preferentially executed than first content having a low execution priority is present among print jobs stored in the predetermined storage area, the image forming apparatus to execute, together with the print job having the second content, a print job having the first content stored in the predetermined storage area.

This specification also relates to an image forming apparatus including: a job receiving unit configured to receive a print job; a job discriminating unit configured to discriminate content of the print jobs received by the job receiving unit; and a job managing unit configured to cause a storage medium to temporarily store, in a predetermined storage area, a print job discriminated by the job discriminating unit as having first content with a low execution priority and cause the image forming apparatus to execute, at predetermined timing set in advance, the print job having the first content stored in the predetermined storage area.

This specification also relates to an image forming apparatus including: a fixing device configured to heat and fix a toner image on a sheet; a temperature-information acquiring unit configured to acquire information concerning a temperature state of the fixing device; a job receiving unit configured to receive a print job; a job discriminating unit configured to discriminate content of the print job received by the job receiving unit; and a job managing unit configured to cause a storage medium to temporarily store, in a predetermined storage area, a print job discriminated by the job discriminating unit as having first content with a low execution priority and cause, if it is determined on the basis of the information acquired by the temperature-information acquiring unit that the fixing device has temperature equal to or higher than predetermined temperature, the image forming apparatus to execute the print job having the first content stored in the predetermined storage area.

### DESCRIPTION OF THE DRAWINGS

FIG. 1 is a longitudinal sectional view of the schematic configuration of an image forming apparatus according to a first embodiment of the present invention;

FIG. 2 is a functional block diagram for explaining the image forming apparatus according to the first embodiment;

FIG. 3 is a diagram of a screen display example of a print setting screen of a printer driver in a terminal apparatus that transmits a print job to the image forming apparatus according to the first embodiment;

FIG. 4 is a flowchart for explaining a flow of processing in the image forming apparatus according to the first embodiment;

FIG. 5 is a flowchart for explaining a flow of processing in the image forming apparatus according to the first embodiment;

FIG. 6 is a flowchart for explaining a flow of processing in the image forming apparatus according to the first embodiment;

FIG. 7 is a flowchart for explaining a flow of processing in the image forming apparatus according to the first embodiment;

FIG. 8 is a flowchart for explaining a flow of processing in the image forming apparatus according to the first embodiment;

FIG. 9 is a diagram of an example of a condition table used in determining presence or absence of execution of a print job;

FIG. 10 is an operation conceptual diagram of an operation image of an image forming apparatus in the past in a model case;

FIG. 11 is an operation conceptual diagram of an operation image of the image forming apparatus according to the first embodiment in the model case;

FIG. 12 is a table of a comparison result of power consumptions in the model case shown in FIGS. 10 and 11;

FIG. 13 is a functional block diagram for explaining functions of an image forming apparatus according to a second embodiment of the present invention;

FIG. 14 is a functional block diagram for explaining functions of an image forming apparatus according to a third embodiment of the present invention; and

FIG. 15 is a functional block diagram for explaining functions of an image forming apparatus according to a fourth embodiment of the present invention.

### DETAILED DESCRIPTION

Embodiments of the present invention are explained below with reference to the accompanying drawings.

### First Embodiment

First, a first embodiment of the present invention is explained.

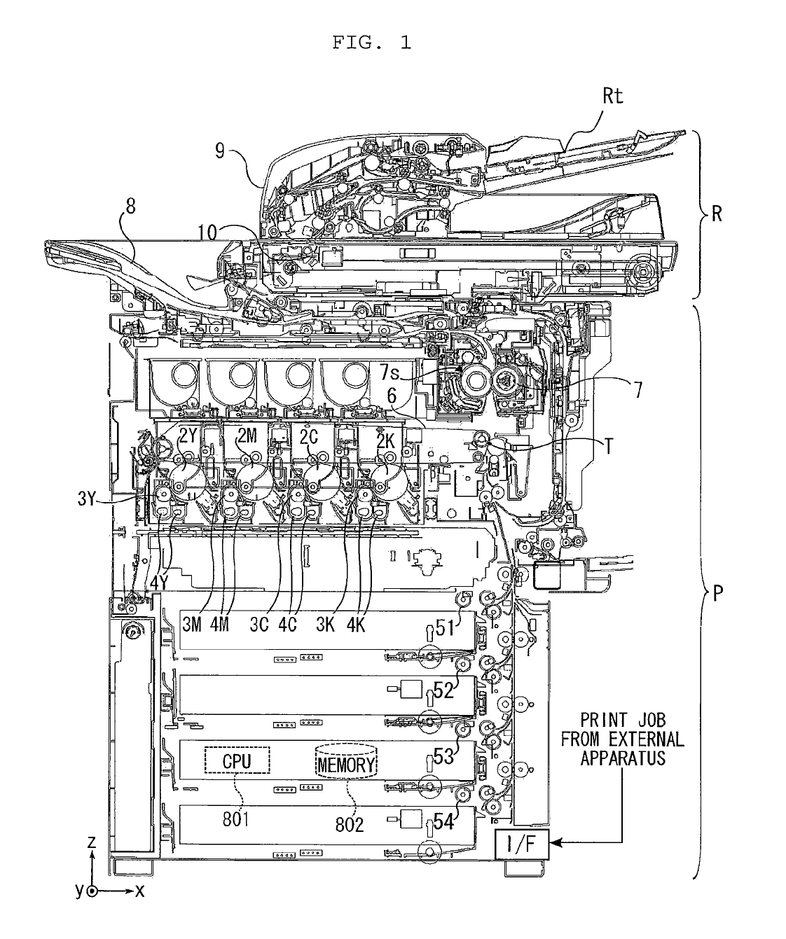

FIG. 1 is a longitudinal sectional view of a schematic configuration of an image forming apparatus (MFP: Multi Function Peripheral) according to the first embodiment.

As shown in FIG. 1, the image forming apparatus according to this embodiment includes an image reading unit R and an image forming unit P.

The image reading unit R has a function of scanning to read images of a sheet document and a book document.

The image forming unit P has a function of forming a toner image on a sheet on the basis of, for example, an image read from an original document by the image reading unit R or image data transmitted from an external apparatus to the image forming apparatus.

The image reading unit R includes an auto document feeder (ADF) 9 that can automatically convey an original document to a predetermined image reading position. The image reading unit R reads, with a scanning optical system 10, an image of an original document automatically conveyed by the auto document feeder 9 and placed on a document tray (a predetermined document placing table) Rt or an original document placed on a not-shown document table.

The image forming unit P includes pickup rollers 51 to 54, photoconductive members 2Y to 2K, developing rollers 3Y to 3K, mixers 4Y to 4K, an intermediate transfer belt 6, a fixing device 7, and a discharge tray 8.

The image forming apparatus according to this embodiment includes a CPU 801 and a memory 802 (see FIG. 1). The CPU 801 has a role of performing various kinds of processing in the image forming apparatus and also has a role of realizing various functions by executing computer programs stored in the memory 802 (a predetermined storage area). The memory 802 can include a RAM (Random Access Memory), a ROM (Read Only Memory), a DRAM (Dynamic Random Access Memory), a SRAM (Static Random Access Memory), and a VRAM (Video RAM). The memory 802 has a role of storing various kinds of information and computer programs used in the image forming apparatus.

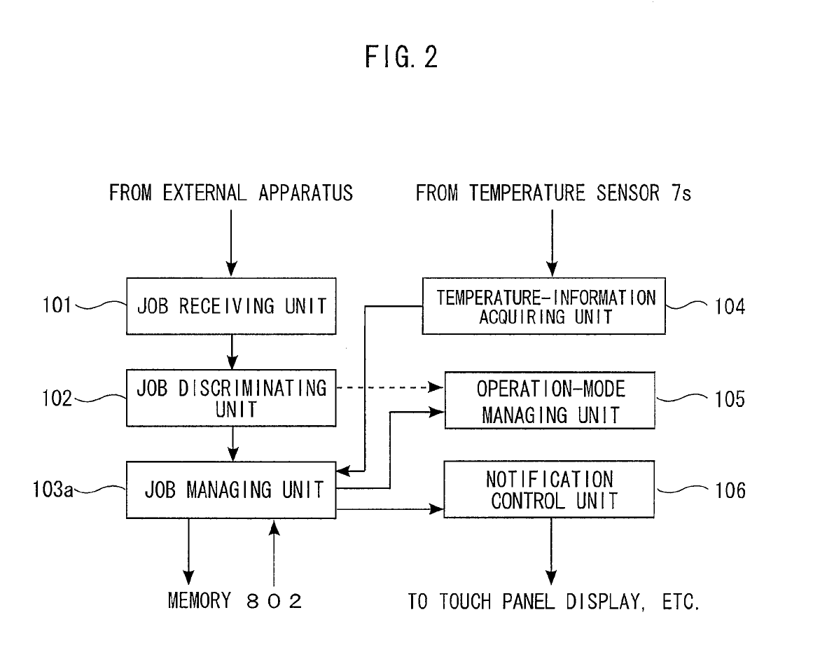

The image forming apparatus according to this embodiment includes a not-shown touch panel display 803 having a function of an operation input unit configured to receive an operation input of a user and a function of a display unit configured to screen-display various processing results and the like in the image forming apparatus (see FIG. 2 referred to later).

An overview of copy processing is explained as an example of processing in the image forming apparatus according to this embodiment.

First, sheets picked up from cassettes by the pickup rollers 51 to 54 are fed into a sheet conveying path. The sheets fed into the sheet conveying path are conveyed in a predetermined conveying direction by plural roller pairs.

Images of plural sheet documents automatically conveyed continuously by the auto document feeder 9 are read by the scanning optical system 10 in the predetermined image reading position.

Image processing and the like is performed on the basis of image data of red (R), green (G), and blue (B) of the images read from the original documents by the image reading unit R to create image data of yellow (Y), magenta (M), cyan (C), and black (K). The image data of Y, M, C, and K is sent to a writing control unit (a laser, a LED, etc.). Electrostatic latent images are formed on photoconductive surfaces of the photoconductive members 2Y, 2M, 2C, and 2K for transferring toner images onto the sheets.

Subsequently, developers agitated by mixers 4Y to 4K (equivalent to agitating units) in developing devices are supplied to the photoconductive members 2Y to 2K, on which the electrostatic latent images are formed as explained above, by the developing rollers (so-called magnetic rollers) 3Y to 3K. Consequently, the electrostatic latent images formed on the photoconductive surfaces of the photoconductive members 2Y, 2M, 2C, and 2K are visualized as toner images.

The toner images formed on the photoconductive members 2Y, 2M, 2C, and 2K in this way are transferred onto a belt surface of the intermediate transfer belt 6 (so-called primary transfer). The toner images are conveyed by the rotation of the intermediate transfer belt 6. In a predetermined secondary transfer position T, the toner images are transferred onto the sheets conveyed to the predetermined secondary transfer position T.

The toner images transferred onto the sheets are heated and fixed on the sheets by the fixing device 7. Temperature information of a heating member and a pressing member included in the fixing device 7 (information concerning a temperature state of the fixing device 7) is detected by a temperature sensor 7s and acquired by a temperature-information acquiring unit 104 explained later (see FIG. 2 referred to later).

The sheets having the toner images heated and fixed thereon are conveyed through the conveying path by plural conveying roller pairs and sequentially discharged onto the discharge tray 8.

FIG. 2 is a functional block diagram for explaining the image forming apparatus according to the first embodiment.

As shown in the figure, the image forming apparatus according to the first embodiment includes a job receiving unit 101, a job discriminating unit 102, a job managing unit 103a, a temperature-information acquiring unit 104, an operation-mode managing unit 105, and a notification control unit 106.

The job receiving unit 101 receives a print job transmitted to the image forming apparatus according to this embodiment through, for example, a network.

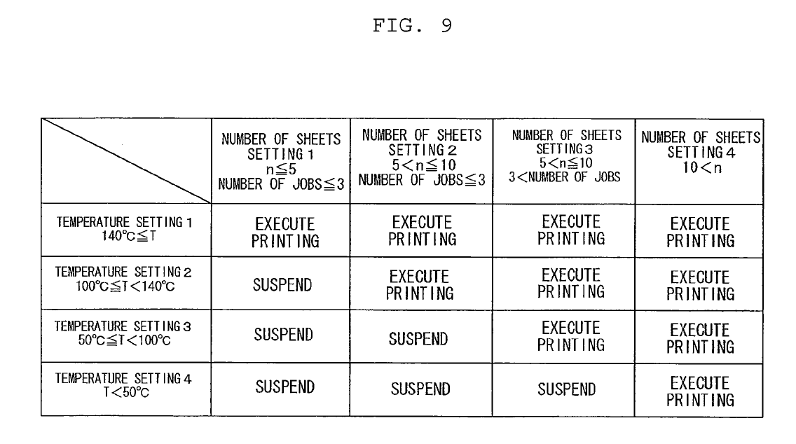

The job discriminating unit 102 discriminates content of the print job received by the job receiving unit 101 on the basis of predetermined table data (see FIG. 9 referred to later) or the like stored in the memory 802 or the like.

The print job is a print job having “first content” or a print job having “second content”.

The print job having the “first content” means, for example, a print job for which a flag is set that indicates that the print job is not a target of preferential execution in a printer driver that transmits the print jobs to the image forming apparatus or a print job for which no special flag is set.

The print job having the “second content” means, for example, a print job for which the flag is set that indicates preferential execution in the printer driver that transmits the print jobs to the image forming apparatus.

A method of setting a flag used for discrimination of types of print jobs and a method of discriminating the types of the print jobs are not limited to the example explained above. It goes without saying that a print job for which no special flag is set may be discriminated as a second job.

It is not always necessary to discriminate, on the basis of the flag, which of the first content and the second content a print job as a discrimination target corresponds to. It is also possible to perform the discrimination on the basis of, for example, content of print setting in the print job or information obtained by totaling some parameters concerning plural print jobs.

The job managing unit 103a causes, for example, the memory 802 to temporarily store a print job discriminated by the job discriminating unit 102 as having the “first content” with a low execution priority. In this embodiment, in an example explained below, for convenience of explanation, a storage destination of a print job is the memory 802. However, the storage destination is not limited to this. The storage destination may be, for example, a not-shown hard disk usually included in the image forming apparatus or a storage area included in an external apparatus such as a server that can communicate with the image forming apparatus.

The job managing unit 103a causes the image forming apparatus to execute, together with the print job having the “first content” stored in the memory 802, a print job discriminated by the job discriminating unit 102 as having the “second content” that should be more preferentially executed than the “first content”.

“Together” in this context does not always mean that print jobs are started to be executed at the same timing but means that plural print jobs, which should be executed “together”, are continuously executed. When the plural print jobs are continuously executed without temporal interval, it is possible to substantially reduce work for warming a fixing device, which cools as time elapses after executing a print job once, again for a print job that should be executed next.

When the job discriminating unit 102 discriminates that a print job received by the job receiving unit 101 is a print job having the “second content”, the job managing unit 103a causes the image forming apparatus to execute the print job having the “first content” stored in the memory 802 after executing the print job having the “second content”.

The job managing unit 103a causes the memory 802 to temporarily store a print job discriminated by the job discriminating unit 102 as having predetermined content with a low execution priority. The job managing unit 103a can also cause the image forming apparatus to execute all print jobs stored in the memory 802 if a sum of “predetermined parameters” concerning all the print jobs stored in the memory 802 exceeds a predetermined value.

Examples of the “predetermined parameters” in this embodiment include (1) the number of printed sheets set in a print job and (2) the number of accumulated jobs of print jobs accumulated in the memory 802.

The temperature-information acquiring unit 104 acquires information concerning a temperature state of the fixing device 7 (e.g., detected temperature [° C.]) from the temperature sensor 7s.

If it is determined on the basis of the information acquired by the temperature-information acquiring unit 104 that the temperature of the fixing device 7 is equal to or higher than the predetermined temperature, the job managing unit 103a causes the image forming apparatus to execute the print job having the first content stored in the memory 802. When the fixing device 7 is in a temperature state in which printing can be performed, if an accumulated suspended print job is executed simultaneously with the print job, it is unnecessary to warm up the fixing device 7 only for the suspended print job. Therefor, it is possible to contribute to energy saving.

When the image forming apparatus does not execute a print job, the operation-mode managing unit 105 puts the image forming apparatus on standby in an operation mode for turning off at least power supply to the fixing device 7. When the image forming apparatus executes a print job, the operation-mode managing unit 105 causes the image forming apparatus to execute print processing from an operation mode for turning off the power supply to the fixing device 7 (heating of the fixing device 7). Examples of the operation mode for turning off the power supply to the fixing device 7 include a “power saving mode”, a “sleep mode”, a “super sleep mode”, a “standby mode”, and an “energy saving mode”.

When the print job having the “first content” stored in the memory 802 is executed, the notification control unit 106 notifies a user of the execution of the print job having the first content using (1) screen display on a touch panel display 803 as an operation panel and (2) sound notification performed by using a speaker usually included in the image forming apparatus.

In this embodiment, a predetermined flag arbitrarily set by the user is set in a print job received by the image forming apparatus. The predetermined flag is set on a setting screen of a printer driver in an external apparatus such as a PC that transmits a print job to the image forming apparatus according to this embodiment.

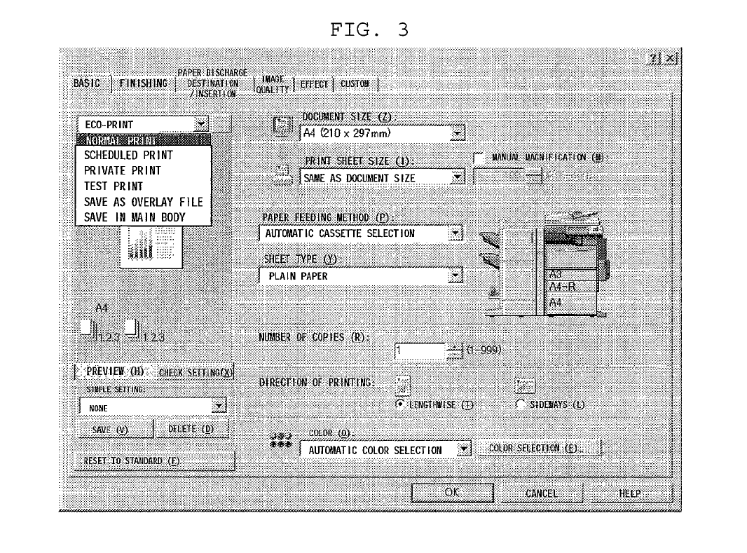

FIG. 3 is a diagram of a screen display example of a print setting screen of a printer driver in a terminal apparatus that transmits a print job to the image forming apparatus according to this embodiment.

The user sets a desired job type in a setting-target print job from a pull-down menu Q for selecting a job type displayed on the upper left of the print setting screen of the printer driver.

Various job types such as “eco-print”, “normal print”, “scheduled print”, “private print”, “test print”, “save in an overlay file”, and “save in a main body” can be selected and set.

A job type selected in this way is included in data of a print job as flag information. Specifically, in this embodiment, it is assumed that a print job for which “eco-print” is selected as a job type is equivalent to the “print job having the first content”.

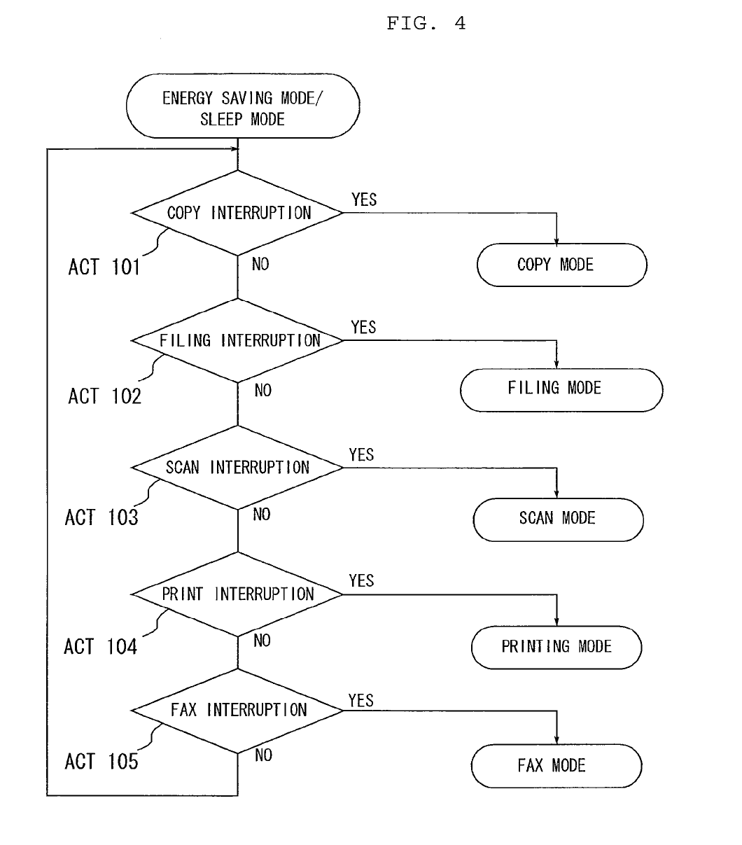

A flow of processing in the image forming apparatus according to the first embodiment is explained with reference to flowcharts shown in FIGS. 4 to 8.

FIG. 4 is a flowchart for explaining operation performed by the image forming apparatus in the “energy saving mode” or the “sleep mode”.

The image forming apparatus according to this embodiment waits for interruption such as copy interruption (ACT 101), filing interruption (ACT 102), scan interruption (ACT 103), printing interruption (ACT 104), and FAX interruption (ACT 105). For example, if the job receiving unit 101 receives a print job anew, the operation-mode managing unit 105 shifts the operation mode to the “printing mode”.

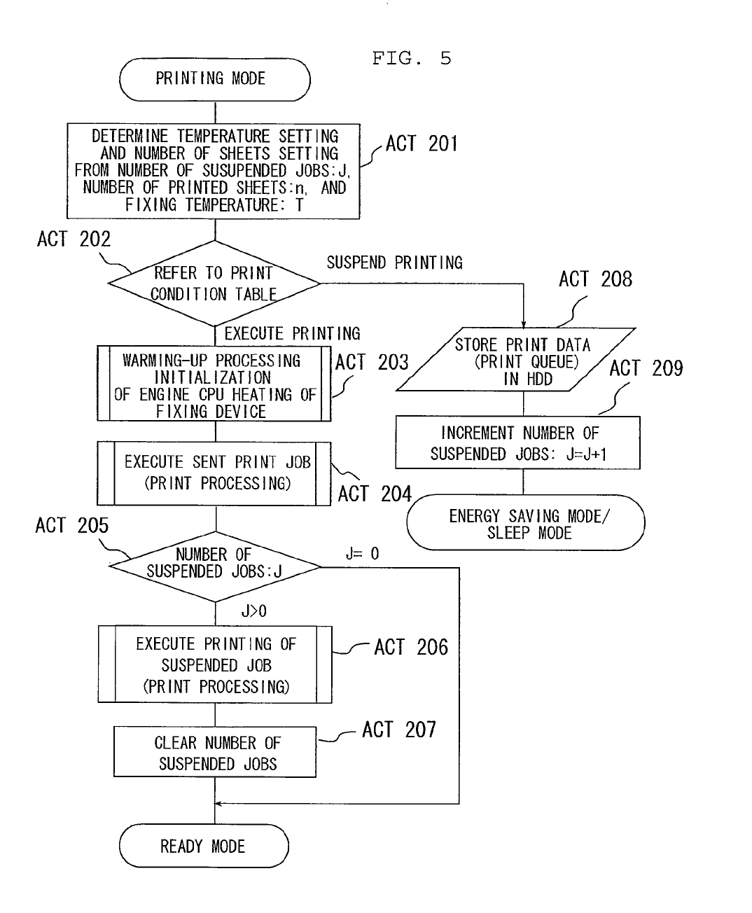

FIG. 5 is a flowchart for explaining a flow of processing in a state in which the operation mode of the image forming apparatus shifts to the “printing mode”.

In the printing mode, the job discriminating unit 102 determines a reference condition for a condition table on the basis of (1) the number of print jobs J suspended in the memory 802, (2) a sum n of “the number of printed sheets set in the print jobs suspended in the memory 802” and “the number of printed sheets set in a print job received anew”, and (3) the temperature T [° C.] of the fixing device 7 detected by the temperature sensor 7s (ACT 201).

The job managing unit 103a refers to a predetermined condition table (see FIG. 9 referred to later) on the basis of the determined reference condition (ACT 202) and determines whether a print job should be executed or suspended. The condition table (FIG. 9) used for determining presence or absence of execution of the print job can be stored in, for example, the memory 802. However, the storage of the condition table is not limited to this. The condition table may also be stored in, for example, a storage area of an external apparatus such as a server that can refer to data in the job managing unit 103a or the hard disk included in the image forming apparatus.

When the job receiving unit 101 receives a print job for which “eco-print” is set as a job type, the job managing unit 103a that receives the print job set with a flag of “eco-print” checks the temperature of the fixing device 7, the number of print jobs stored and suspended in the memory 802, and a total number of printed sheets of the print job received anew and the print jobs suspended in the memory 802. The job managing unit 103a determines, on the basis of a result of the check and according to the condition table shown in FIG. 9, whether the print job is executed or stored in the memory 802 as a suspended print job.

For example, when a job with a job type set in “normal print” (equivalent to the print job having the second content) is received or a copy job (involving print operation and equivalent to the print job having the second content) is received in a state in which a print job with a job type “eco-print” is suspended in the memory 802, the operation-mode managing unit 105 causes the image forming apparatus in a sleep state to return to an operation mode, in which print processing is possible, irrespectively of presence or absence of a suspended print job of “eco-print” (specifically, warming-up operation of the fixing device 7). The print job set in “normal print” is executed. After the print job is executed, the suspended print job for which “eco-print” is set is executed.

For example, when the temperature of the fixing device 7 is lower than 50° C. (temperature setting 4), the number of prints set in a received print job is equal to or smaller than five, and the number of suspended jobs is equal to or smaller than three (number of sheets setting 1), execution of printing operation is suspended and the received print job is suspended.

On the other hand, for example, even when the temperature of the fixing device 7 is lower than 50° C. (temperature setting 4), when the number of prints set in a received print job exceeds ten (number of sheets setting 4), the received print job is executed.

When the print job is suspended, the job managing unit 103a stores the print job (a print queue) to be suspended in the memory 802 (ACT 208), increments the number of suspended jobs stored in the memory 802 or the hard disk (J=J+1) (ACT 209), keeps the operation mode of the image forming apparatus set in the “energy saving mode” or the “sleep mode”, and returns to the interruption waiting state.

When the received print job is executed, the job managing unit 103a starts warming-up processing (initialization of the CPU 801, heating of the fixing device 7, etc.) (ACT 203) and causes the image forming apparatus to execute the received print job (ACT 204). If there is a print job suspended in the memory 802 (J>0 in ACT 205), after causing the image forming apparatus to execute the suspended print job (ACT 206), the job managing unit 103a clears the number of suspended jobs (J=0) (ACT 207) and shifts the image forming apparatus to a Ready mode.

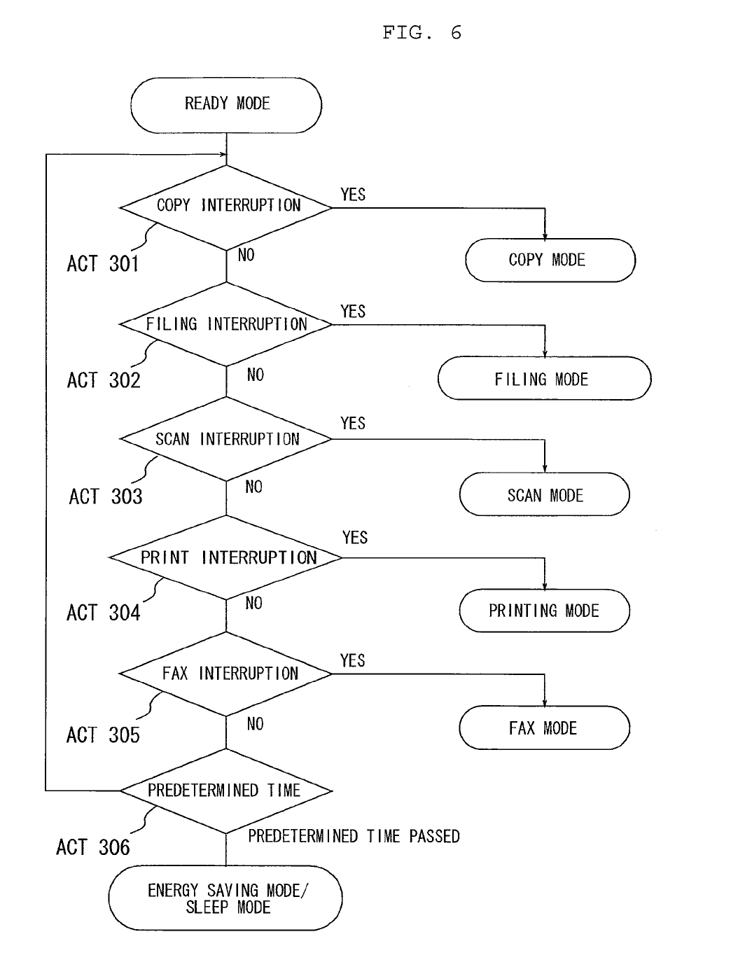

FIG. 6 is a flowchart for explaining a flow of processing in a state in which the image forming apparatus according to the first embodiment is in the “Ready mode”.

In the “Ready mode”, the image forming apparatus waits for interruption such as “copy interruption” (ACT 301), “filing interruption” (ACT 302), “scan interruption” (ACT 303), “print interruption” (ACT 304), and “FAX interruption” (ACT 305). For example, if copy interruption is performed, the operation-mode managing unit 105 shifts the image forming apparatus to a “copy mode”. If no interruption is performed for predetermined time or more, the operation-mode managing unit 105 shifts the image forming apparatus to the energy saving mode or the sleep mode (ACT 306).

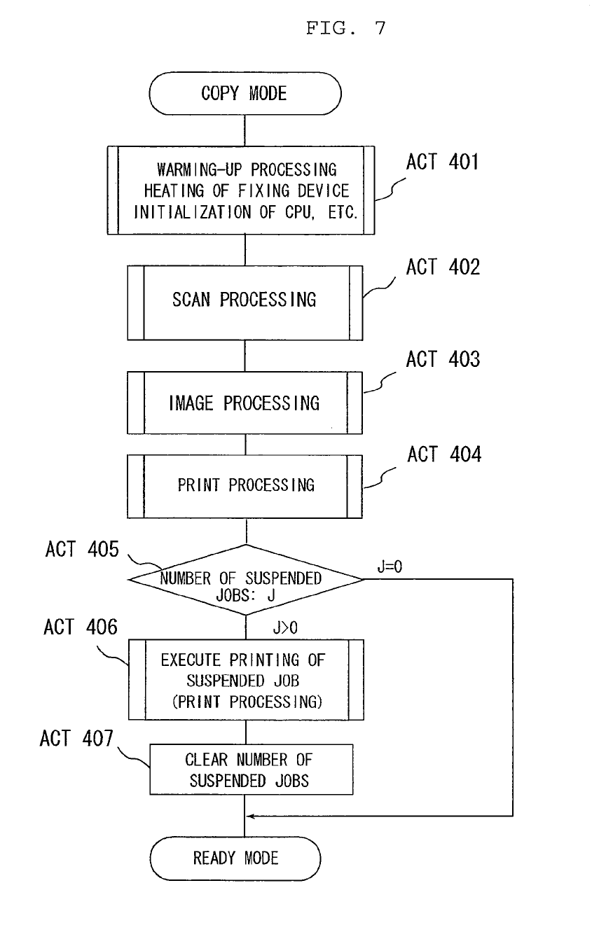

FIG. 7 is a flowchart for explaining a flow of processing in a state in which the image forming apparatus is shifted to the copy mode.

In the processing in the “copy mode”, first, the job managing unit 103a causes the image forming apparatus to perform warming-up processing (initialization of the CPU 801, heating of the fixing device 7, etc.) (ACT 401). The job managing unit 103a causes the image forming apparatus to perform a series of copy operation including scan processing (ACT 402), predetermined image processing (ACT 403), and print processing (ACT 404). Thereafter, if there is a suspended print job (J>0 in ACT 405), after causing the image forming apparatus to execute printing of the suspended job (ACT 406), the job managing unit 103a clears the number of suspended jobs (J=0) (ACT 407) and shifts the image forming apparatus to the Ready mode.

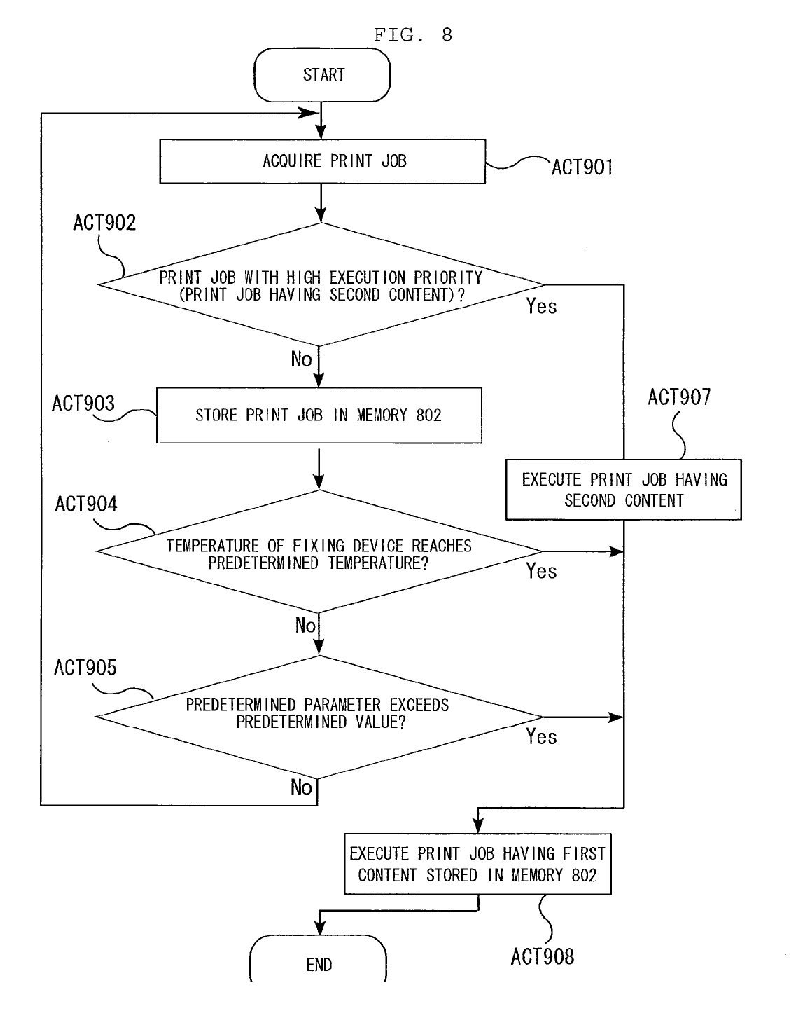

FIG. 8 is a flowchart for explaining a flow of processing in the image forming apparatus according to the first embodiment.

First, the job receiving unit 101 receives a print job transmitted to the image forming apparatus according to this embodiment through, for example, the network (ACT 901).

The job discriminating unit 102 discriminates, on the basis of predetermined table data or the like stored in the memory 802 or the like, content of the print job received by the job receiving unit 101 (ACT 902).

The job managing unit 103a causes, for example, the memory 802 to temporarily store a print job discriminated by the job discriminating unit 102 as having the “first content” with a low execution priority (ACT 903).

The job managing unit 103a causes the image forming apparatus to execute, together with the print job having the “first content” stored in the memory 802, a print job discriminated by the job discriminating unit 102 as having the “second content” that should be more preferentially executed than the “first content” (ACT 907 and ACT 908).

If it is determined on the basis of information acquired by the temperature-information acquiring unit 104 that the temperature of the fixing device 7 is equal to or higher than the predetermined temperature, the job managing unit 103a causes the image forming apparatus to execute the print job having the first content stored in the memory 802 (ACT 904).

The job managing unit 103a causes the memory 802 to temporarily store a print job discriminated by the job discriminating unit 102 as having predetermined content with a low execution priority. If a sum of “predetermined parameters” concerning all print jobs stored in the memory 802 exceeds the predetermined value, the job managing unit 103a can also cause the image forming apparatus to executes all the print jobs stored in the memory 802 (ACT 905).

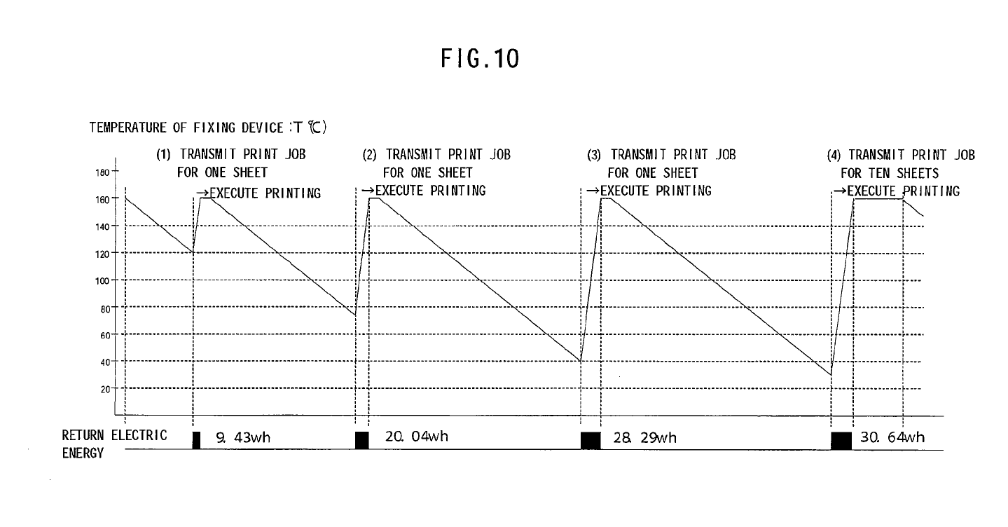

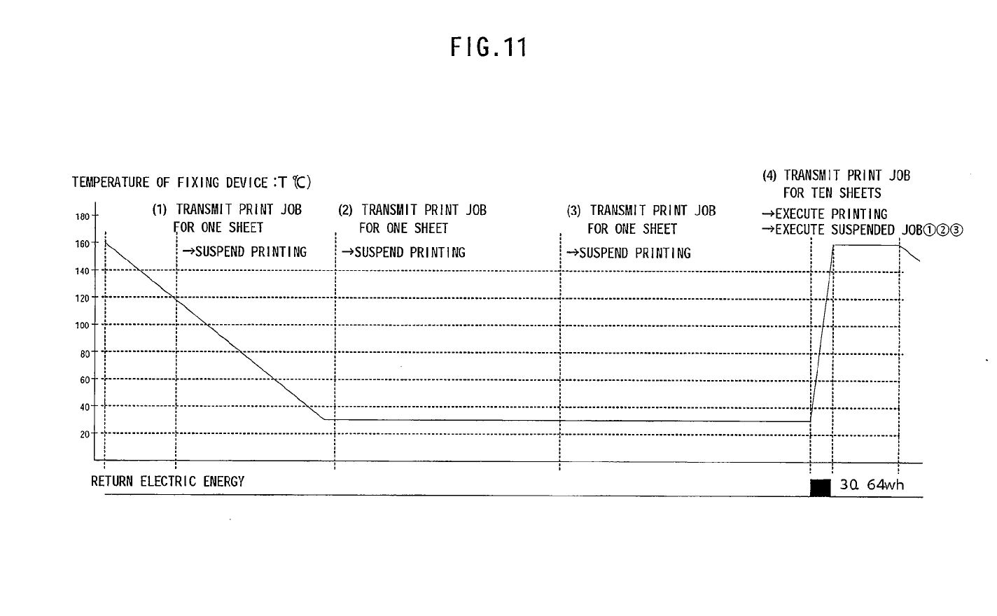

FIGS. 10 and 11 are operation conceptual diagrams of an operation image of the image forming apparatuses in a model case.

In this model case, it is assumed that set temperature of the fixing device 7 of the image forming apparatus is 160° C., warming-up time is 99 seconds, a print job for one sheet is transmitted three times, and a print job for ten sheets is transmitted once. It is assumed that temperatures of the fixing device 7 at the time of reception of the respective print jobs are (1) T=120° C., (2) T=75° C., (3) T=40° C., and (4) T=30° C.

FIG. 10 is an operation conceptual diagram during normal printing in the image forming apparatus in the past.

The image forming apparatus shifts to the sleep mode at the temperature T=160° C. of the fixing device 7 and the temperature of the fixing device 7 descends.

When the temperature of the fixing device 7 reaches (1) T=120° C., the first print job is received by the job receiving unit 101. Then, the temperature of the fixing device 7 rises from (1) T=120° C. to T=160° C. according to the warming-up processing. Electric power required until the temperature of the fixing device 7 reaches T=160° C. is referred to as “return electric energy”. Power consumption at this point was W=9.43 wh. When the temperature of the fixing device 7 reaches T=160° C., the image forming apparatus executes print processing and performs printing of one sheet. Thereafter, when predetermined time elapses, the operation-mode managing unit 105 shifts the image forming apparatus to the sleep mode again. The temperature of the fixing device 7 descends following the shift to the sleep mode.

When the temperature of the fixing device 7 reaches (2) T=75° C., the second print job is received by the job receiving unit 101 and the temperature of the fixing device 7 rises from (2) T=75° C. to T=160° C. according to the warming-up processing. Power consumption from (2) T=75° C. to T=160° C. was “=20.04 wh.

Similarly, power consumption from (3) T=40° C. to T=160° C. was W=28.29 wh. Power consumption from (4) T=30° C. to T=160° C. was W=30.64 wh.

FIG. 11 is an operation conceptual diagram of operation performed when a print job for which eco-print is set as a job type is received in the image forming apparatus according to this embodiment. At the same timing as the operation shown in FIG. 10, the print job having the job type “eco-print” is received. Then, execution of the print jobs in (1), (2), and (3) is suspended. First, the print job in (4) is executed according to the reception of the print job in (4) and the temperature of the fixing device 7 rises from (4) T=30° C. to T=160° C. according to the warming-up processing. Power consumption at that point was W=30.64 wh.

After the completion of the print job in (4), the suspended print jobs in (1) to (3) are also executed.

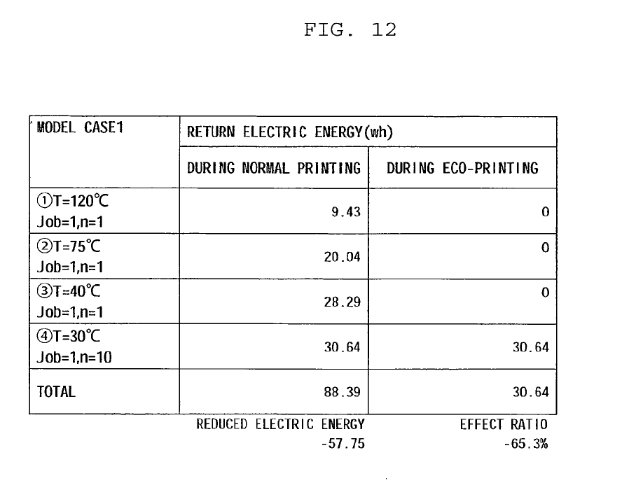

FIG. 12 is a table of a comparison result of power consumptions in the model case shown in FIGS. 10 and 11.

It is seen that, whereas a total of return electric energies during the normal printing (the configuration in the past) was 88.39 wh, return electric energy during eco-printing according to this embodiment was 30.64 wh and the electric energy could be reduced by 57.75 wh (about 65% decrease) with respect to that during the normal printing according to the configuration in the past.

When it is assumed that this reduction is reduction in one day, about 5.8 Kg of CO₂ can be reduced in 300 days (when calculated with 0.000339 t CO₂/KWh of Tokyo Electric Power Company).

As explained above, according to the configuration of this embodiment, it is possible to reduce the number of times of return operation from the sleep mode of the image forming apparatus (the number of times fixing temperature is raised to the predetermined temperature) and realize not only energy saving but also a reduction in CO₂ emission.

### Second Embodiment

A second embodiment of the present invention is explained below.

The second embodiment is an application example of the first embodiment explained above. Components having the same functions as those of the components explained in the first embodiment are denoted by the same reference numerals and signs and explanation of the components is omitted.

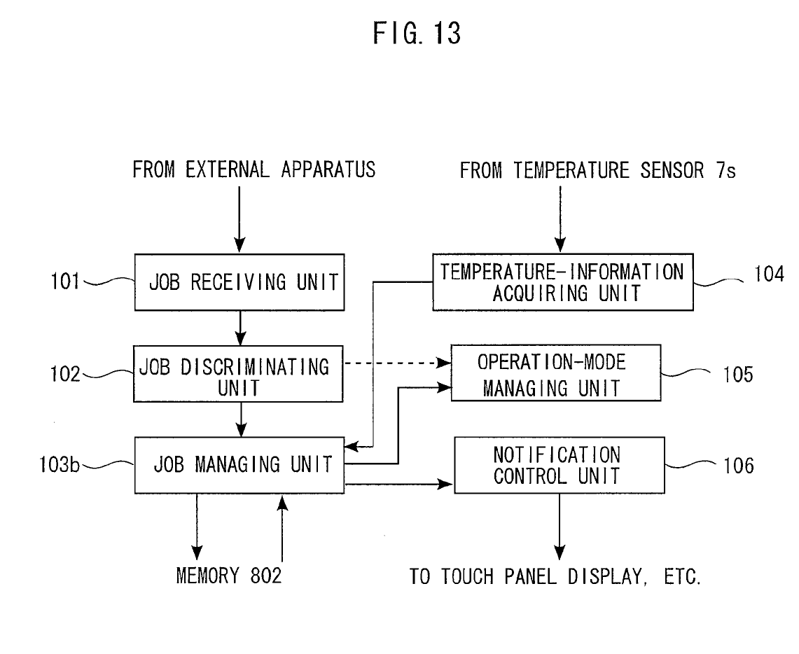

FIG. 13 is a functional block diagram for explaining functions of an image forming apparatus according to the second embodiment. The image forming apparatus according to this embodiment includes the job receiving unit 101, the job discriminating unit 102, a job managing unit 103b, the temperature-information acquiring unit 104, the operation-mode managing unit 105, and the notification control unit 106.

The temperature-information acquiring unit 104 acquires information concerning a temperature state of the fixing device 7.

The job receiving unit 101 receives a print job.

The job discriminating unit 102 discriminates content of the print job received by the job receiving unit 101.

The job managing unit 103b causes the memory 802 to temporarily store a print job discriminated by the job discriminating unit 102 as having the “first content” with a low execution priority. If it is determined on the basis of the information acquired by the temperature-information acquiring unit 104 that the temperature of the fixing device 7 is equal to or higher than predetermined temperature, the job managing unit 103b causes the image forming apparatus to execute the print job having the first content stored in the memory 802.

When the image forming apparatus does not execute a print job, the operation-mode managing unit 105 puts the image forming apparatus on standby in an operation mode for turning off at least power supply to the fixing device 7. When the image forming apparatus executes a print job, the operation-mode managing unit 105 shifts the image forming apparatus from the operation mode for turning off power supply to the fixing device 7 to an operation mode for executing print processing.

When the print job having the “first content” stored in the memory 802 is executed, the notification control unit 106 notifies a user of the execution of the print job having the first content using screen display on the touch panel display 803 as an operation panel and sound notification.

### Third Embodiment

A third embodiment of the present invention is explained below.

The third embodiment is an application example of the first embodiment explained above. Components having the same functions as those of the components explained in the first embodiment are denoted by the same reference numerals and signs and explanation of the components is omitted.

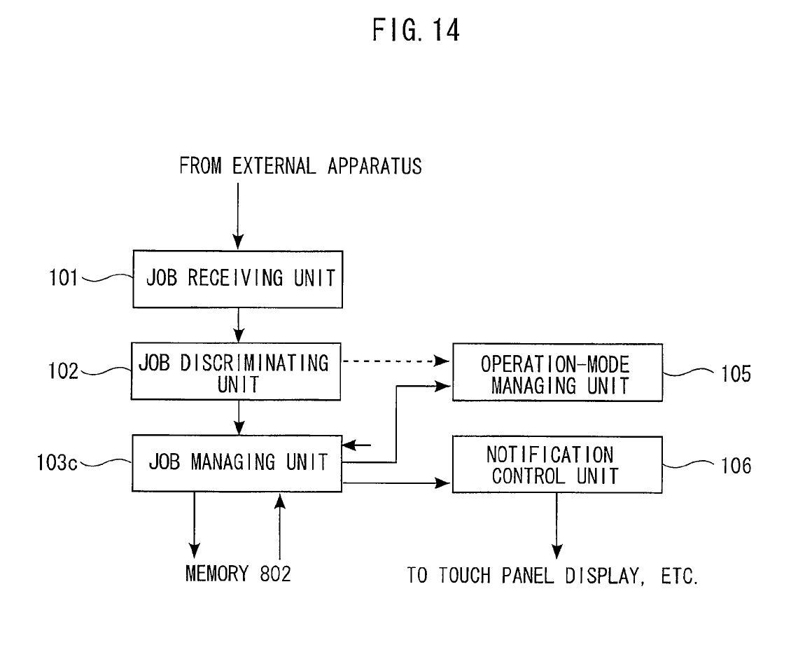

FIG. 14 is a functional block diagram for explaining functions of an image forming apparatus according to the third embodiment. The image forming apparatus according to this embodiment includes the job receiving unit 101, the job discriminating unit 102, a job managing unit 103c, the operation-mode managing unit 105, and the notification control unit 106.

The job receiving unit 101 receives a print job.

The job discriminating unit 102 discriminates content of the print job received by the job receiving unit 101.

The job managing unit 103c causes the memory 802 to temporarily store a print job discriminated by the job discriminating unit 102 as having the first content with a low execution priority. The job managing unit 103c causes the image forming apparatus to execute, at predetermined timing set in advance, the print job having the first content stored in the memory 802.

When the image forming apparatus does not execute a print job, the operation-mode managing unit 105 puts the image forming apparatus on standby in an operation mode for turning off at least power supply to the fixing device 7. When the image forming apparatus executes a print job, the operation-mode managing unit 105 shifts the image forming apparatus from the operation mode for turning off power supply to the fixing device 7 to an operation mode for executing print processing (involving warming-up operation of the fixing device 7).

When the print job having the “first content” stored in the memory 802 is executed, the notification control unit 106 notifies a user of the execution of the print job having the first content using screen display on the touch panel display 803 as an operation panel and sound notification.

### Fourth Embodiment

A fourth embodiment of the present invention is explained below.

The fourth embodiment is an application example of the first embodiment explained above. Components having the same functions as those of the components explained in the first embodiment are denoted by the same reference numerals and signs and explanation of the components is omitted.

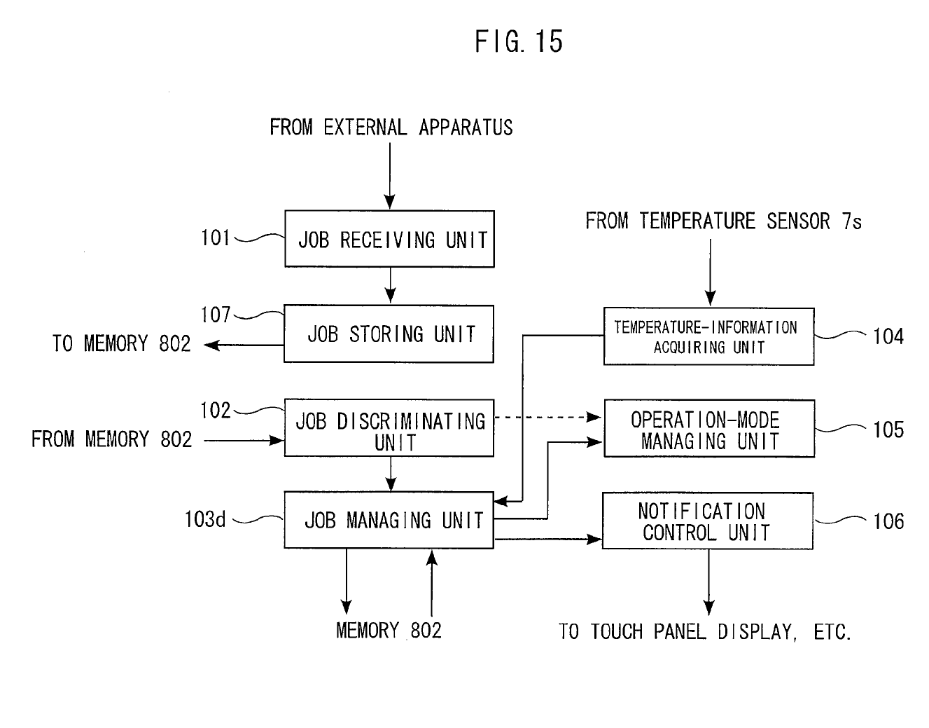

FIG. 15 is a functional block diagram for explaining functions of an image forming apparatus according to the fourth embodiment. The image forming apparatus according to this embodiment includes the job receiving unit 101, a job storing unit 107, the job discriminating unit 102, a job managing unit 103d, the temperature-information acquiring unit 104, the operation-mode managing unit 105, and the notification control unit 106.

The job receiving unit 101 receives a print job.

The job storing unit 107 automatically stores the print job received by the job receiving unit 101 in the memory 802. In a configuration of this embodiment, a storage destination in which a print job is automatically stored is the memory 802. Therefore, it is possible to minimize the number of times of start of a hard disk and contribute to a further reduction in power consumption.

The job discriminating unit 102 discriminates content of the print job stored in the memory 802 by the job storing unit 107.

When a print job discriminated by the job discriminating unit 102 as having a second content that should be more preferentially executed than a first content with a low execution priority is present among print jobs stored in the memory 802, the job managing unit 103d causes the image forming apparatus to execute, together with the print job having the second content, a print job having the first content stored in the memory 802.

The temperature-information acquiring unit 104 acquires information concerning a temperature state of the fixing device 7.

If it is determined on the basis of the information acquired by the temperature-information acquiring unit 104 that the temperature of the fixing device 7 is equal to or higher than predetermined temperature, the job managing unit 103d causes the image forming apparatus to execute the print job having the first content stored in the memory 802.

When the image forming apparatus does not execute a print job, the operation-mode managing unit 105 puts the image forming apparatus on standby in an operation mode for turning off at least power supply to the fixing device 7. When the image forming apparatus executes a print job, the operation-mode managing unit 105 shifts the image forming apparatus from the operation mode for turning off power supply to the fixing device 7 to an operation mode for executing print processing.

When the print job having the “first content” stored in the memory 802 is executed, the notification control unit 106 notifies a user of the execution of the print job having the first content using screen display on the touch panel display 803 as an operation panel and sound notification.

In the example explained in the embodiments, an execution priority of a print job is determined on the basis of a flag set on the printer drive side. However, the present invention is not always limited to this.

For example, it is also conceivable to automatically determine an execution priority of a print job on the basis of contents such as characters and a barcode included in print target image data in the print job.

In the example explained in the embodiments, a print job with a low execution priority is temporarily stored in the storage area and held until the print job satisfies some execution condition. However, the present invention is not limited to this. For example, among print jobs discriminated as having low execution priorities, a print job stored in a predetermined storage area exceeding a predetermined period may be directly canceled without being executed. When a print job is canceled in this way, it is desirable to notify, before performing cancel processing, the user that the cancel processing will be executed for the print job. A method for the notification can be realized not only by registering a message on a server but also by, for example, transmitting an email to a client PC or the like.

The operations in the processing in the image forming apparatus explained above are realized by causing the CPU 801 to execute a print job managing program stored in the memory 802.

A computer program for causing a computer included in the image forming apparatus to execute the operations can be provided as the print job managing program. In the example explained in the embodiments, the computer program for realizing the functions for carrying out the present invention is recorded in advance in the storage area provided in the apparatus. However, the present invention is not limited to this. The same computer program may be downloaded from a network to the apparatus. The same computer program stored in a computer readable recording medium may be installed in the apparatus. The recording medium may be a recording medium of any form as long as the recording medium can store the computer program and can be read by the computer. Specifically, examples of the recording medium include an internal storage device internally mounted in the computer such as a ROM or a RAM, a portable storage medium such as a CD-ROM, a flexible disk, a DVD disk, a magneto-optical disk, or an IC card, a database that stores a computer program, another computer and a database of the computer, or a transmission medium on a line. Functions obtained by previous installation or download in this way may realize the functions in cooperation with an OS (operating system) or the like in the apparatus.

A part of the computer program or the entire computer program may be a dynamically-generated execution module.

It is possible to carry out the present invention in various other forms without departing from the spirit or the main characteristics thereof. Therefore, the embodiment is merely an illustration in every aspect and should not be limitedly interpreted. The scope of the present invention is indicated by the scope of claims and by no means is limited by the text of the specification. Further, all alterations, various improvements, substitutions, and modifications belonging to a range of equivalents of the scope of claims are included in the scope of the present invention.

As explained above in detail, according to the present invention, it is possible to provide a technique for preventing an increase in power consumption due to intermittent execution of print jobs with low execution priorities and contribute to a reduction in CO₂ emission.

What is claimed is:

1. An image forming apparatus comprising:
a job receiving unit configured to receive a print job;
a job discriminating unit configured to discriminate content of the print job received by the job receiving unit; and
a job managing unit configured to cause a storage medium to temporarily store, in a predetermined storage area, a print job discriminated by the job discriminating unit as having first content with a low execution priority and cause the image forming apparatus to execute, together with the print job having the first content stored in the predetermined storage area, a print job discriminated by the job discriminating unit as having second content that should be more preferentially executed than the first content.

2. The apparatus according to claim 1, wherein the job managing unit causes, if a print job received by the job receiving unit is discriminated by the job discriminating unit as having the second content, the image forming apparatus to execute the print job having the first content stored in the predetermined storage area after causing the image forming apparatus to execute the print job having the second content.

3. The apparatus according to claim 2, further comprising:
a fixing device configured to heat and fix a toner image on a sheet; and
a temperature-information acquiring unit configured to acquire information concerning a temperature state of the fixing device, wherein
the job managing unit causes, if a temperature of the fixing device is determined to be equal to or higher than predetermined temperature, on the basis of the information acquired by the temperature-information acquiring unit, the image forming apparatus to execute the print job having the first content stored in the predetermined storage area.

4. The apparatus according to claim 1, further comprising:
a fixing device configured to heat and fix a toner image on a sheet; and
an operation-mode managing unit configured to put, if the image forming apparatus does not execute a print job, the image forming apparatus on standby in an operation mode for turning off at least power supply to the fixing device.

5. The apparatus according to claim 1, further comprising a notification control unit configured to notify, if the print job having the first content stored in the predetermined storage area is executed, the user of the execution of the print job having the first content.

6. The apparatus according to claim 1, wherein the print job having the second content is a print job for which a flag indicating preferential execution is set by a printer driver that transmits the print job to the image forming apparatus.

7. An image forming apparatus comprising:
a job receiving unit configured to receive a print job;
a job discriminating unit configured to discriminate content of the print job received by the job receiving unit; and
a job managing unit configured to cause a storage medium to temporarily store, in a predetermined storage area, a print job discriminated by the job discriminating unit as having first content with a low execution priority and cause, if a sum of predetermined parameters concerning all print jobs stored in the predetermined storage area exceeds a predetermined value, the image forming apparatus to execute all the print jobs stored in the predetermined storage area.

8. The apparatus according to claim 7, wherein the predetermined parameters include a number of prints set in a print job.

9. The apparatus according to claim 7, wherein the predetermined parameters include a number of accumulated jobs of the print jobs stored in the predetermined storage area.

10. The apparatus according to claim 7, further comprising:
a fixing device configured to heat and fix a toner image on a sheet; and
an operation-mode managing unit configured to put, if the image forming apparatus does not execute a print job, the image forming apparatus on standby in an operation mode for turning off at least power supply to the fixing device.

11. The apparatus according to claim 7, further comprising a notification control unit configured to notify, if the print job having the predetermined content stored in the predetermined storage area is executed, the user of the execution of the print job having the predetermined content.

12. An image forming apparatus comprising:
a job receiving unit configured to receive a print job;
a job storing unit configured to cause a storage medium to store the print job received by the job receiving unit in a predetermined storage area;
a job discriminating unit configured to discriminate content of the print job stored in the predetermined storage area by the job storing unit; and
a job managing unit configured to cause, if a print job discriminated by the job discriminating unit as having second content that should be more preferentially executed than first content having a low execution priority is present among print jobs stored in the predetermined storage area, the image forming apparatus to execute, together with the print job having the second content, a print job having the first content stored in the predetermined storage area.

13. The apparatus according to claim 12, further comprising:
a fixing device configured to heat and fix a toner image on a sheet; and
a temperature-information acquiring unit configured to acquire information concerning a temperature state of the fixing device, wherein
the job managing unit causes, if a temperature of the fixing device is determined to be equal to or higher than predetermined temperature, on the basis of the information acquired by the temperature-information acquiring unit, the image forming apparatus to execute the print job having the first content stored in the predetermined storage area.

14. The apparatus according to claim 12, further comprising:
a fixing device configured to heat and fix a toner image on a sheet; and
an operation-mode managing unit configured to put, if the image forming apparatus does not execute a print job, the image forming apparatus on standby in an operation mode for turning off at least power supply to the fixing device.

15. The apparatus according to claim 12, further comprising a notification control unit configured to notify, if the print job having the first content stored in the predetermined storage area is executed, the user of the execution of the print job having the first content.

16. The apparatus according to claim 12, wherein the print job having the second content is a print job for which a flag indicating preferential execution is set.
